(19) United States
(12) Patent Application Publication
(10) Pub. No.: US 2009/0185956 A1
(43) Pub. Date: Jul. 23, 2009

(54) pH SENSITIVE INDICATOR DEVICE

(76) Inventors: Michael Carl Junger, Brookfeild (AU); Kim John Giliam, Wakerley (AU)

Correspondence Address: BRINKS HOFER GILSON & LIONE/CHICAGO/COOK, PO BOX 10395, CHICAGO, IL, 60610, US

(21) Appl. No.: 12/353,779

(22) Filed: Jan. 14, 2009

Related U.S. Application Data
(60) Provisional application No. 61/011,597, filed on Jan. 18, 2008.

(51) Int. Cl. G01N 21/00

(52) U.S. Cl. 422/86

(57) ABSTRACT

A pH sensitive indicator device comprises a body including at least a portion of a translucent or transparent gas permeable material and an acid base colour change or halochromic material in or associated with the gas permeable material. The halochromic material can be received in a recess within the body of a gas permeable material or incorporated into the body of a gas permeable material. The gas permeable material can comprise a silicone elastomer.

### RELATED APPLICATIONS

The present patent document claims the benefit of the filing date under 35 U.S.C. §119(e) of Provisional U.S. Patent Application Ser. No. 61/011,597, filed Jan. 18, 2008, which is hereby incorporated by reference.

### TECHNICAL FIELD

This invention relates to a pH sensitive indicator device and more particularly to a pH sensitive indicator device based upon colour change of an indicator material. One particular application to which the present invention may be directed is in relation to cell culturing and more particularly to monitoring of pH during cell culturing but the invention is not limited to this application.

### BACKGROUND OF THE INVENTION

Colour change of an indicator material can be referred to as halochromism. That is, a material which changes colour with change in pH. Throughout this specification the term halochromic material is used when referring to such materials.

In cell culturing applications such as in vitro fertilization cell culture, it is important to regulate the environment to ensure healthy cell growth. An important parameter to be monitored is pH of the culture media. It has been proposed to add visual indicators such as phenol red added to culture media to enable a visual check of pH. However, the presence of an indicator may compromise growth of the cell within the media. Further the optimal pH range required is quite narrow and changes in colour can be difficult to pick up with the naked eye. The culturing cell may be in an incubator which makes visual observation difficult.

pH of media in incubators is often regulated with carbon dioxide gas. When culture vessels are removed from an incubator changes on carbon dioxide concentration can change the pH of the culture medium in the culture vessels and it is desirable that any change can be monitored.

In our earlier patent application, INCUBATION CONDITION MONITORING DEVICE, PCT/US2007/008777 (WO2007/120619), the contents of which are incorporated herein in their entirety, the pH was monitored by placing a portion of a culture medium equivalent to that in a culture vessel into a cuvette in a reader unit and the pH change in that cuvette read as pH change in the culture vessel as both are open to the same atmosphere. A problem with such a system is that the culture medium in the cuvette evaporates and must be replaced from time to time, and also that the cuvette must mimic the response time of the culture medium in the culture vessel and the resulting geometry to achieve this may not be suitable or overlarge.

It is the object of this invention to provide an alternate and improved form of pH indicator cell or at least provide the practitioner with a useful alternative.

### SUMMARY

In one embodiment, the invention relates to a pH sensitive indicator device comprising a body including at least a portion of which comprises a translucent or transparent gas permeable material and a halochromic material in or associated with the gas permeable material.

In one embodiment the halochromic material is received in a recess within the body of the gas permeable material. Alternatively the halochromic material is incorporated into the body of the gas permeable material.

The halochromic material can comprise, but is not limited to, the following: gentian violet, methyl violet, leucomalachite green, thymol blue, methyl yellow, bromophenol blue, congo red, methyl orange, bromocresol green, methyl red, azolitmin, bromocresol purple, bromothymol blue, phenol red, neutral red, naphtholphthalein, cresol red, phenolphthalein, thymolphthalein or alizarine yellow or any other naturally occurring or synthetic acid base colour change indicator material. Synthetic reactive materials may also be used.

In one embodiment, the gas permeable material comprises a silicone elastomer.

In another embodiment, the pH sensitive indicator device can comprise a solid structure (a sheet, rod or block) of a compounding of the halochromic material and an un-cured silicone monomer which is subsequently cured and formed into the translucent or transparent gas permeable material of a selected solid structure. Before curing the material can be formed into the selected structure. Alternatively, the desired structure can be machined from the cured material.

In a further embodiment, the pH sensitive indicator device can comprise a hollow body of a translucent or transparent gas permeable material, such as a silicone elastomer and a halochromic material with the halochromic material placed into the hollow body by the use of a hypodermic syringe or any other suitable method. Alternatively, a solid structure, for example, a cube can have one or more faces made of a silicone elastomer. This allows a device to be made that can have a faster or slower reaction time depending on how much of the external area can be exposed to atmosphere.

The hollow body may also include a reservoir volume to keep a main hollow section full after evaporative losses which may occur through the translucent or transparent gas permeable material.

In an alternative embodiment, the pH sensitive indicator device can comprise a strip of material that is made up of plurality of sections, each section incorporating a different halochromic material that will respond to different pH ranges, i.e., 0-2, 2-4, etc, up to pH 14. Hence, each of the sections has a colour or colour change, which represents that particular pH range. A visual determination of pH can therefore be made by matching the strip colour with the reference colour once the device has been exposed to the test solution or environment. Because the halochromic material is immobilized into the translucent or transparent gas permeable material the pH sensitive indicator device may be reusable.

In one embodiment, the pH sensitive indicator device of the present invention may be incorporated into an incubation monitoring device. The incubation monitoring device can comprise means to retain a culture vessel and an associated reader unit to measure at least temperature around the culture vessel and pH of the medium within the culture vessel, the reader unit including an optical means to measure pH by reading the colour of the pH sensitive indicator device, which is retained into the reader unit and exposed to atmosphere within the incubator.

Alternative applications of the pH sensitive indicator according to the present invention may be to determine the pH of the water in a swimming pool or the pH of the concrete foundations of a building.

A strip of pH sensitive indicator material could be used much like litmus paper as a visual indicator of pH.

A block or strip of pH sensitive indicator according to the present invention could be placed in a fish tank to monitor changes in pH.

In an alternative embodiment, the pH sensitive indicator may be in the form of a gel that can be used in nappies to indicate pH change due to urine ingress.

In an alternative embodiment, the pH sensitive indicator may be in the form of a component of a device in which pH sensitive material are processed. One such example is with some specific applications for use in assisted reproduction.

For instance, it may be used with an ovum pick-up needle whereby an aspiration line or test tube stopper could be made of a pH sensitive indicator material according to the present invention that would indicate that an extracted fluid is obtained at the correct pH. This would indicate via the appropriate colour or pH reading that the eggs obtained were done so with conditions at there most favourable. Similarly a transfer catheter that would be used for the implantation of the fertilised egg could indicate when conditions in the uterus have deteriorated to the point where the procedure may not be effective.

### DESCRIPTION OF THE DRAWINGS

This then generally describes the invention but to assist with understanding reference will now be made to the accompanying drawings in which:

FIG. 1 shows an exemplary embodiment of pH sensitive indicator device according to the present invention;

FIG. 2 shows an alternative embodiment of a pH sensitive indicator device according to the present invention;

FIG. 3 shows an alternative embodiment of a pH sensitive indicator device according to the present invention;

FIG. 4 shows a perspective view of one embodiment of a reader unit incorporating a pH sensitive indicator device of the present invention; and

FIG. 5 shows a cutaway view of the reader unit of FIG. 4.

### DETAILED DESCRIPTION

Unless defined otherwise, all technical and scientific terms used herein have the same meaning as commonly understood to one of ordinary skill in the art to which this invention belongs.

The terms “adapted for” or “configured to” while referring to an element of the H sensate indicator device described herein mean that the element is changed, modified, or specifically designed so that it is suitable to perform a specified or desired function.

As used herein, “in or associated with” means formulated, incorporated, placed or arranged in a particular order to define the relationship between elements, components or materials of a device. The term “in or associated with” can include, without being limited to, terms, such as, disposed, placed, arranged, distributed, mixed, formulated, or incorporated.

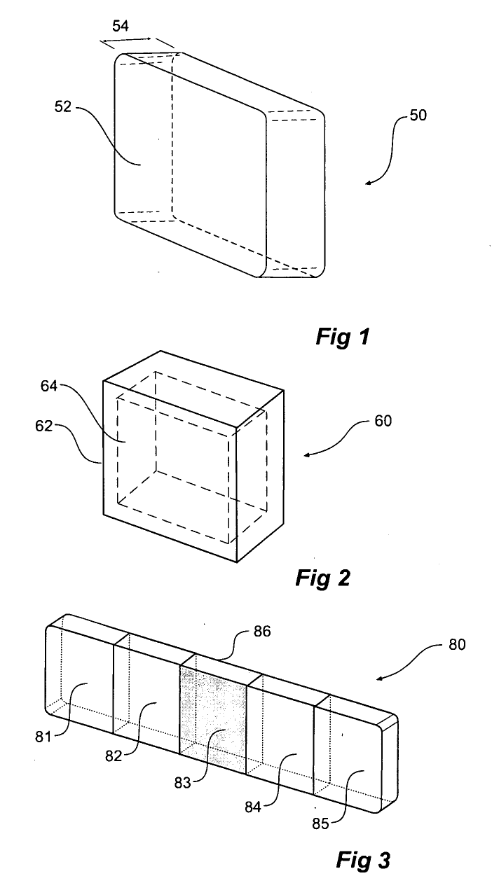

In one embodiment shown in FIG. 1, the pH sensitive indicator device 50 comprises a body 52 of a translucent gas permeable material, such as a silicone elastomer. The gas permeable material is formulated from a silicone material and a halochromic material, i.e., an acid base indicator and then molded into an integral body. The silicone material when cured is permeable to gas. The body has a thickness 54, which may be from 1 mm to 5 mm for some applications but may be thicker or thinner depending upon the application to which the pH sensitive indicator device is intended to be used. The thickness used depends on how long the response time and intended life is desired to be. The thickness is such as to allow enough thickness of indicator and gas permeation throughout the thickness and allowing for light to pass through it for purposes of reading a change in colour indication pH change. The thickness will be determined by the intended use, for example, cell culture where a very quick response is required will be very thin. A sensor that may be imbedded in concrete can have a slow response time but due to slow evaporation will last for years.

In one example, the silicone material of the body may be Wacker 3003-30 and the halochromic material is phenol red. Further indicators may also be used separately or in combination. The resulting material had the required elastomeric and gas permeable properties and was coloured red at a pH equivalent of pH 7.2.

To test the pH sensitive indicator device, one sheet having a thickness of 1 mm was placed in a closed environment, MINC mini incubator (Cook Australia, Qld, Australia) set at 37 degrees C., humidified gas 6% CO₂, 5% 0₂/N₂, nitrogen filler and another sheet having a thickness of 1 mm was left in atmosphere. The result was positive in that there was a colorimetric change between the sheets that was easily identifiable.

An alternative embodiment of the invention, as shown in FIG. 2, comprises a pH sensitive indicator device according to another embodiment of the invention. In this embodiment, the pH sensitive indicator device 60 comprises a container 62 formed from a translucent and gas permeable material. The container has a recess 64 within it and in the recess is a halochromic material. A suitable halochromic material may for instance be a bicarbonate buffered phenol red solution.

The halochromic material may evaporate through the gas permeable material and hence the device can be disposable or can be recharged by the halochromic material being replaced in the hollow body for example by the use of a hypodermic syringe.

FIG. 3 shows an alternative embodiment of a pH sensitive indicator device according to the present invention. In this embodiment, the pH sensitive indicator device 80 comprises a strip of translucent or transparent gas permeable material that is made up of different sections 81, 82, 83, 84 and 85, each section incorporating a different halochromic material that will respond to different pH ranges. The gas permeable material is formulated from an unpolymerised silicone material and a series of halochromic materials to give different pH ranges, molded into an integral body 86 and then polymerised. The body 86 can have a thickness ranging from a thin membrane to a thick block several hundred millimeters thick. Hence, each of the sections has a colour or a colour change which represents a particular pH range. A visual determination of pH can be made by matching the strip colour with the reference colour once the device has been exposed to the test solution or environment. Because the halochromic material is immobilized into the translucent or transparent gas permeable material, the pH sensitive indicator device may be reusable.

Tabulated below (TABLE 1) are several halochromic materials which could be used in the present invention as pH indicators. Indicators usually exhibit intermediate colors at pH values inside the listed transition range. For example, phenol red exhibits an orange color between pH 6.8 and pH 8.4. The transition range may shift slightly depending on the concentration of the indicator in solution and on the temperature at which it is used.

TABLE 1

| | Low pH | Transition | |
|---|---|---|---|
| Indicator | color | pH range | High pH color |
| Gentian violet (Methyl violet) | yellow | 0.0-2.0 | blue-violet |
| Leucomalachite green (first | yellow | 0.0-2.0 | green |
| transition) | | | |
| Thymol blue (first transition) | red | 1.2-2.8 | yellow |
| Methyl yellow | red | 2.9-4.0 | yellow |
| Bromophenol blue | yellow | 3.0-4.6 | purple |
| Congo red | blue-violet | 3.0-5.0 | red |
| Methyl orange | red | 3.1-4.4 | yellow |
| Bromocresol green | yellow | 3.8-5.4 | blue-green |
| Methyl red | red | 4.4-6.2 | yellow |
| Azolitmin | red | 4.5-8.3 | blue |
| Bromocresol purple | yellow | 5.2-6.8 | purple |
| Bromothymol blue | yellow | 6.0-7.6 | blue |
| Phenol red | yellow | 6.8-8.4 | purple |
| Neutral red | red | 6.8-8.0 | yellow |
| Naphtholphthalein | colorless | 7.3-8.7 | greenish to |
| | to reddish | | blue |
| Cresol Red | yellow | 7.2-8.8 | reddish-purple |
| Thymol blue (second transition) | yellow | 8.0-9.6 | blue |
| Phenolphthalein | colorless | 8.2-10.0 | fuchsia |
| Thymolphthalein | colorless | 9.3-10.5 | blue |
| Alizarine Yellow R | yellow | 10.2-12.0 | red |
| Leucomalachite green (second | green | 11.6-14 | colorless |
| transition) | | | |

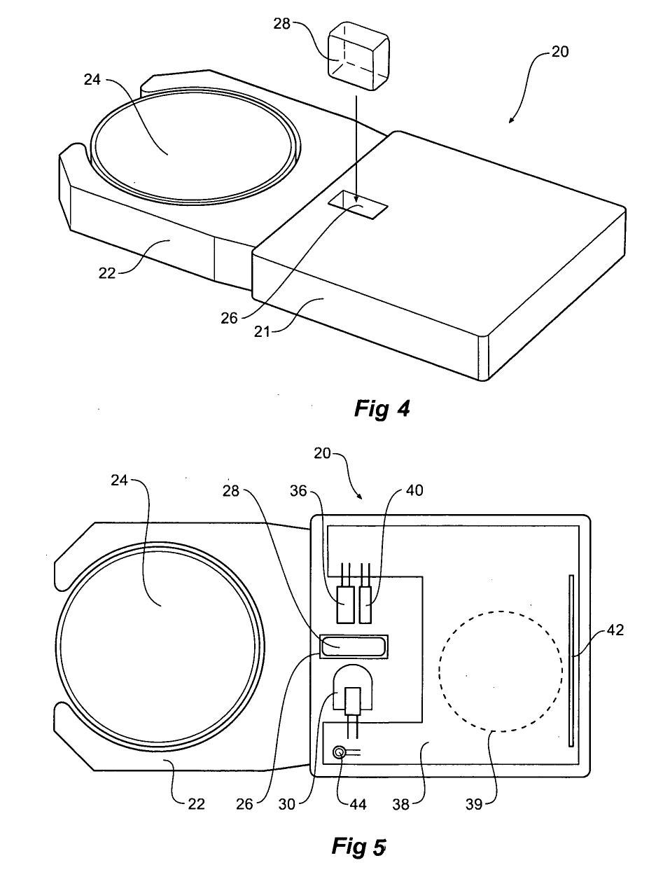

FIG. 4 shows one embodiment of the condition monitoring reader unit incorporating a pH sensitive block according to the present invention and FIG. 5 shows a cutaway view of the reader unit of FIG. 4.

The reader unit 20 has a reader body 21 and a gripper 22 to receive and retain a culture vessel 24. The gripper may be of any convenient size to grip and carry a culture vessel. For instance, the gripper may be made of silicone elastomer and be sized to grip and retain a 35 mm culture dish. This enables a culture dish to be transported with the reader unit to enable monitoring to be continued outside the incubator. The reader body 21 includes a slot or recess 26 for a pH sensitive indicator device 28, according to the present invention.

Within the reader body, as shown in FIG. 5, there is a LED light source arrangement 30 comprised of a set of LEDs of different wavelengths or a single LED transmitting two or more wavelengths and directed to a LED receiver assembly 36 so that the light passes across the slot 26 to the LED receiver assembly 36. The pH sensitive indicator device 28 is received in the slot 26. The LED receiver assembly 36 includes receivers for each of the wavelengths of the LED light source arrangement. Electronic circuitry 38 processes the various readings and a battery 39 (underneath the electronic circuitry and shown dotted) makes the reader unit self contained. Adjacent to the LED receiver assembly 36 is a second LED receiver 40, which measures and compensates for drift in the transmitting LED assembly 30. An aerial 42 associated with the electronic circuitry transmits readings to a data logger within the incubator or to a monitoring device outside the incubator. The reader unit also includes a thermistor 44 to measure temperature and the electronic circuitry 38 can transmit temperature data as well as pH data.

A version of the reader unit as shown in FIGS. 4 and 5 may be supplied without the gripper. Such a device can be used to monitor a whole incubator chamber and act as a warning device, setting off an alarm when pH or temperature moves outside preset limits.

A preferred embodiment of the reader unit comprises a fully sealed unit so it can withstand spillages, with packaging made from a suitable plastic which can be cleaned and sterilized. The reader unit may be either re-chargeable, or have a battery which either lasts a sufficiently long time, or is replaceable.

Throughout this specification various indications have been given as to the scope of this invention but the invention is not limited to any one of these but may reside in two or more of these combined together. The examples are given for illustration only and not for limitation.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

1. A pH sensitive indicator device comprising a body, at least a portion of which comprises a translucent or transparent gas permeable material and a halochromic material in or associated with the gas permeable material.

2. The pH sensitive indicator device of claim 1, wherein the halochromic material is received in a recess within the body of a gas permeable material.

3. The pH sensitive indicator device of claim 1, wherein the body comprises both solid non permeable walls and solid walls the numbers of each dependant on the desired use.

4. The pH sensitive indicator device of claim 1, wherein the halochromic material is incorporated into the body of the gas permeable material.

5. The pH sensitive indicator device of claim 1, wherein the halochromic material is selected from the group consisting of gentian violet, methyl violet, leucomalachite green, thymol blue, methyl yellow, bromophenol blue, congo red, methyl orange, bromocresol green, methyl red, azolitmin, bromocresol purple, bromothymol blue, phenol red, neutral red, naphtholphthalein, cresol red, phenolphthalein, thymolphthalein and alizarine yellow, and any other naturally occurring or synthetic acid base colour change indicator material.

6. The pH sensitive indicator device of claim 1, wherein the gas permeable material comprises a silicone elastomer.

7. The pH sensitive indicator device of claim 1, comprising a solid structure of a compounding of the halochromic material and an un-cured silicone monomer, the un-cured silicone monomer being subsequently cured and formed into the translucent or transparent gas permeable material of a selected solid structure.

8. The pH sensitive indicator device of claim 1, wherein the solid structure is a sheet, a rod, or a block.

9. The pH sensitive indicator device of claim 1, comprising a strip of material comprising a plurality of sections, each section incorporating a different halochromic material that will respond to different pH ranges.

10. The pH sensitive indicator device of claim 1, wherein the device is configured to use to determine the pH of the water in a swimming pool

11. The pH sensitive indicator device of claim 1, wherein the device is configured to use to determine the pH of the concrete foundations of a building.

12. The pH sensitive indicator device of claim 1, wherein the device is configured to be placed in a fish tank to monitor changes in pH in the fish tank.

13. The pH sensitive indicator device of claim 1, the device being in the form of a gel that used in nappies to indicate pH change due to urine ingress.
